(19) United States
(12) Patent Application Publication
(10) Pub. No.: US 2008/0014555 A1
(43) Pub. Date: Jan. 17, 2008

(54) Mechanical Connection Device for Use in Implantology

(76) Inventor: Gianluca Cippiciani, Perugia (IT)

Correspondence Address: Armstrong, Kratz, Quintos, Hanson & Brooks;Intellectual Property Law Offices, 502 Washington Avenue, Suite 220, Towson, MD, 21204, US

(21) Appl. No.: 11/597,973

(22) PCT Filed: May 25, 2005
(86) PCT No.: PCT/IT05/00300

§ 371 Date: Nov. 29, 2006

(30) Foreign Application Priority Data
May 31, 2004 (IT) MC2004A000073

(51) Int. Cl. A61C 8/00

(52) U.S. Cl. 433/173

(57) ABSTRACT

The present invention refers to a mechanical connection device for use in implantology, comprising a fixture to be tightened to the bone and an prosthetic abutment to be inserted into a suitable internal hole of the fixture, in which the abutment is fixed by means of a plug inserted inside the abutment provided with a through axial hole.

The present patent application for industrial invention refers to a mechanical connection device for use in implantology.

Implantology is a very well known technique used to implant a dental crown by means of a titanium screw integrated in the bone to replace the original tooth, either fallen or removed.

A close examination of the prior technique has identified remarkable disadvantages and therefore the purpose of the present invention is to eliminate them.

To better explain the characteristics and advantages of the device of the invention this document continues with a brief description of the current state of the art.

According to traditional systems, the crown to be implanted is associated with a screw (technically defined as abutment) contained and blocked in a housing (technically defined as fixture) screwed into the patient's maxillary or mandibular bone, or other bony seat.

In particular, connection between abutment and implantation must be of reversible type, since abutment removal might be necessary in case of future complications.

Most of the systems that are currently available on the market can be divided into two main types that differ in the connection mode; in particular, reference is made to screwed-in and conometric systems.

In practical terms, according to screwed-in systems the abutment associated with each dental crown consists in a threaded metal screw that is screwed up into the corresponding implantation consisting in a small hollow cylinder with internal and external threading.

The long-standing use of this type of implantation has shown the onset of significant biological, mechanical and biomechanical complications.

From the biological viewpoint, screwed-in implantations are not able to obtain total accuracy in the connection between abutment and implantation (in the spikes of threading and screw).

The lack of accuracy creates small spaces between abutment and implantation that, in spite of their very small micron size favour the bacteria accumulation inside the implantation body, creating a anaerobic environment that favours the production and accumulation of exotoxins responsible for the reduction of crestal bone and development of infections.

Even when the aforementioned spaces are extremely small in size and cause no problems in static conditions (that is to say before mastication starts), they can cause practical problems during mastication, creating a pump-like effect that, due the space increase, attracts oral fluids inside the implantation.

The mechanical inconveniences of screwed-in implantation systems especially occur during the first year of operation and consist in loosening and possible breakage of the fixing screw and abutment.

From the biomechanical viewpoint, both manufacturing processes of implantation parts and laboratory prosthetic phases create dimensional discrepancies of up to 100-104 microns, thus making it practically impossible to reach passivity.

This condition becomes even more difficult to obtain when the prosthesis is supported by multiple implantations; in this case excessive spaces, concentricity errors, etc. occur easily.

According to conometric systems, a truncated-conical implantation is positioned on the patient's bone to receive the truncated-conical abutment and obtain a self-blocking connection.

However, in order to be reliable, this type of connection must comply with some fundamental requirements, such as total geometrical accuracy, axial loading, presence of traction and compression stresses, and lack of torsion stresses.

These requirements are difficult to comply with and therefore according to standard practices truncated-conical abutments are subject to cementation before their engagement in the fixture.

However, the use of cement to seal and optimize the contact between the implantation parts originates in irreversible connection, thus eliminating the future possibility of removing the implantation parts in case of need.

Moreover, the use of cement, especially in large quantities, can generate inflammatory phenomena with consequent implantation loss.

The purpose of the present invention is to provide a connection device for implantation use capable of innovating the aforementioned technical and overcome the relevant drawbacks.

The present invention is based on the introduction of a new mechanical connection system between abutment and fixture; in particular, this system can provide a connection characterised by high accuracy and reliability, thus totally eliminating the possible creation of spaces or gaps that are the cause of the aforementioned problems.

Moreover, the new system is can be removed easily and quickly, therefore allowing to remove the implantation parts if necessary.

Another advantage of the connection device of the invention refers to the fact that no cement is used to stabilize the implantation parts.

The new connection device of the invention is based on the stable connection between abutment and fixture by means of mere friction, and not with screws or cement.

In the connection device of the invention, the fixture screwed into the patient's bone is provided with an axial hole with preferably truncated-conical profile that receives the truncated-conical point with larger cross-section of the abutment.

To that end, the profile of the fixture hole and the profile of the abutment point must be coupled with slight undercut in order to prevent the occasional uncoupling of the parts in absence of an energetic traction force.

Furthermore, the abutment point is provided with two or more regularly space axial notches that create corresponding longitudinal wings provided with intrinsic flexibility.

It can be said that the structure of the abutment point can be considered similar to a spindle.

The truncated-conical point is engaged inside the fixture hole; because of their intrinsic flexibility, when the wings engage in the walls of the fixture hole, they interfere with the said walls and get closer to each other.

However, the small interference between the abutment point and the internal walls of the fixture is not sufficient to prevent the occasional removal of the abutment from the implantation in case of a traction force.

In order to make connection stable, a plug is engaged into a longitudinal hole drilled on the abutment; the said plug penetrates to the abutment point and acts as a wedge, exercising a divaricating force with radial direction from the inside to the outside with respect to the aforementioned wings.

Because of the presence of the plug, the interference between the abutment wings and the internal walls of the fixture is stronger and capable to prevent occasional uncoupling of the implantation parts in axial direction.

As a matter of fact, the two parts can be uncoupled only after removing the plug-wedge engaged inside the abutment and bringing the abutment point back to the “soft” interference state against the internal walls of the fixture; the slight interference does not prevent the operator to extract the abutment from the friction with a simple traction movement.

For major clarity, the description of the invention continues with reference to the enclosed drawing, which is intended for purpose and not in a limiting sense, whereby:

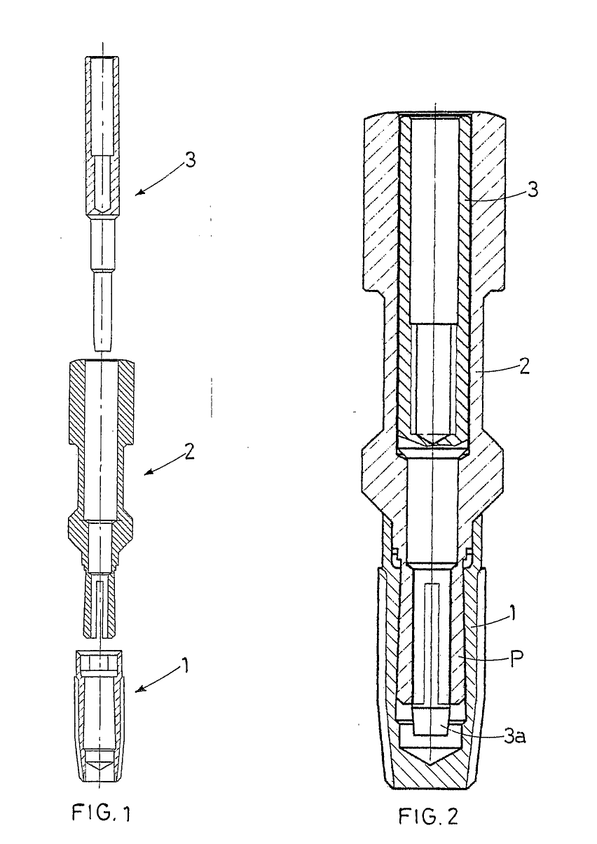

FIG. 1 is an exploded view of the device of the invention;

FIG. 2 is a view showing the parts of the device of the invention assembled in operational position;

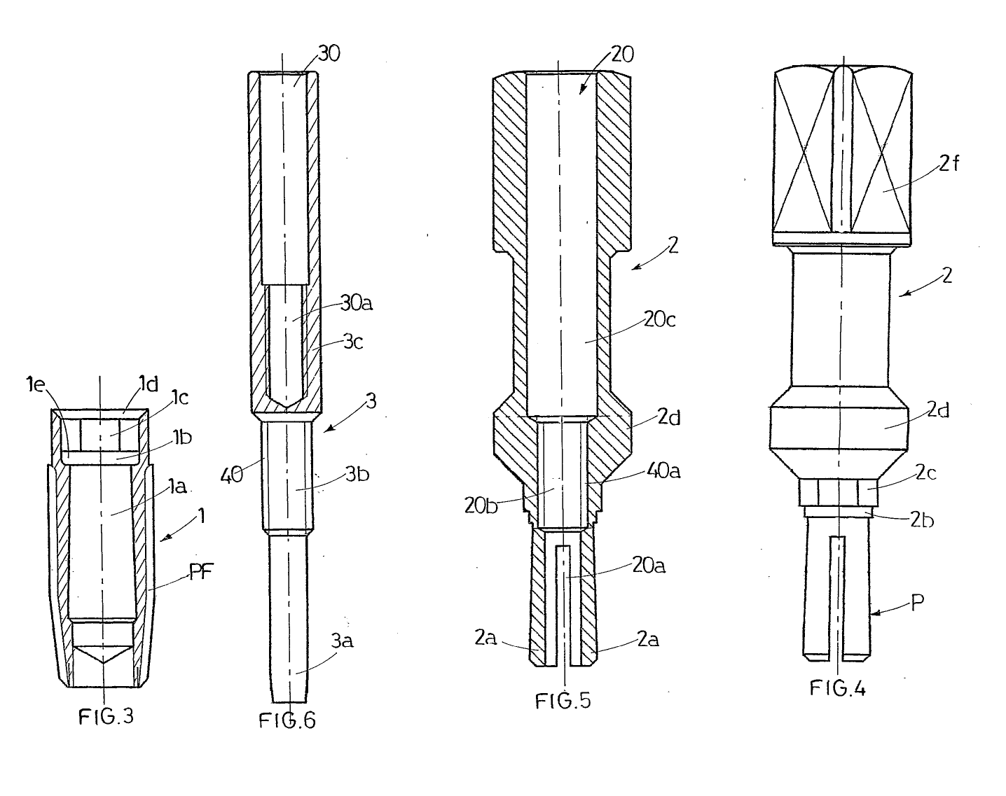

FIG. 3 is a cross-section with an axial plane of the fixture used in the device of the invention;

FIG. 4 is a view of the abutment;

FIG. 5 is a cross-section of the abutment with an axial plane;

FIG. 6 is a view of the plug used to fix the abutment.

With reference to the aforementioned figures, the connection device of the invention is composed of three metal parts, preferably made of titanium, consisting in a fixture (1), an abutment (2) designed to axially engage inside the fixture (1) and a plug (3) designed to axially engage inside the abutment (2).

In particular, the fixture (1) has a basically cylindrical structure with threaded external wall (PF), characterised by the presence of a special longitudinal cavity with differentiated cross-section,

The said cavity is provided with a dead hole (1a) provided with smooth walls with slightly tapered profile; the hole (1a) extends along fixture (1) up to its point.

An annular section (1b) with higher cross-section is provided above the hole (1a), being provided with an upper border (1c) with hexagonal profile.

As shown in FIG. 3, the hexagonal border (1c) is connected with the cavity of the fixture (1) by means of a small section with flared perimeter walls (1d).

The figure also shows that the different cross-section of the section (1a) and section (1b) creates a perimeter step (1e).

As shown in FIGS. 4 and 5, the abutment (2) has a tubular structure with a longitudinal hole (20) designed to receive the plug (3).

The abutment (2) is provided with a spindle-line point (P) with basically truncated-conical structure, composed of multiple longitudinal wings (2a) characterised by intrinsic flexibility.

The cross-section of the point of the abutment (2) is slightly larger than the hole (1a) of the fixture (1); however, when the point (P) is engaged in the hole (1a), the intrinsic flexibility of the wings (2a) allows the wings to get closer to each other during the interference with the walls of the hole (1a).

With reference to FIG. 2, the insertion of the point (P) of the abutment (2) in the fixture (1) is completed when the section with hexagonal profile (2c) located upstream the annular profile (2b) engages inside the corresponding hexagonal section (1c) on the inside of the fixture (1).

In particular, the mutual coupling between the two hexagonal sections (2c and 1c) of the abutment (2) and the fixture (1) prevent the occasional mutual rotation of the abutment (2) inside the fixture (1).

An enlarged head (2d) is provided upstream the hexagonal section (2c) of the abutment (2) with a projecting stem (2f) used to apply the crown.

With reference to FIG. 6, the plug (3) has a variable cross-section that allows for exact engagement inside the axial hole (20) inside the abutment (2).

The plug (3) ends with a slightly conical pin (3a) designed to divaricate the wings (2a) of the abutment and having a slightly larger cross-section than the through hole (20a) bordered by the wings (2a).

In central position, the plug (3) has a section (3b) with larger cross-section designed to exactly house inside the corresponding section (20b) of the hole (20) of the abutment (2); an upper cylindrical section (3c) with larger cross-section is designed to exactly engage inside the corresponding section (20c) of the internal hole (20) of the abutment (2).

The last section (3c) of the plug (3) is provided with an axial hole (30) with a bottom threaded section (30a) used to engage the threaded point of a suitable extracting tool used to remove the plug (3) from the abutment (2).

The extraction of the plug (3) occurs before the extraction of the abutment (2) from the fixture (1) and could not performed without the extracting tool since the plug (3) is cut flush with the top of the abutment (2) when it is positioned in the abutment (2).

No section of the plug (3) projects from the abutment (2) and therefore it is impossible to grab the plug (3) and extract it from its operational position.

The extraction of the plug (3) by means of the threaded extracting tool can only be performed after traumatically removing the crown fixed to the abutment (2); in fact the removal of the crown allows the dentist to access the hole (30a) of the plug (3) with the extracting tool and remove the abutment (2) from the fixture (1) easily, after removing the plug (3) and thus removing the energetic interference between the wings (2a) of the abutment (2) and the walls of the cylindrical hole (1a) on the fixture (1).

Preferably, the plug (3) is provided with threading (40) on the section (3b) that engages with the threading (40a) on the section (20b) of the hole (20) obtained on the abutment (2).

Because of the helicoidal coupling, the plug (3) can be easily and gradually inserted in the abutment (2) by tightening the plug (3) inside the abutment (2), rather than forcing the plug (3) in axial direction, as provided in the case of the first embodiment of the plug (3) (that is to say, without external threading).

1. Mechanical connection device for use in implantology, of the type composed of a prosthetic abutment (2) ending with a pointed element (P) and provided with a through axial tube (20) designed to exactly engage a plug (3) and a fixture (1) featuring an external threading (PF) and an internal hole (1a) designed to receive said pointed element (P) which is composed of multiple flexible wings (2a) bordering through hole (20a), device characterised in that;
said hole (1a) is provided with smooth walls with slightly tapered profile that is to say the diameter of hole (1a) gradually and continuously increases as the distance from the bottom (F) of hole (1a) decreases;
said pointed element (P) has a truncated-conical profile that is to say its diameter progressively and continuously increases as the distance to the ending section (S) decreases the diameter of said section (S) being slightly larger than the diameter of hole (1a);
said plug (3) ends with a lower tapered pin (3a) designed to engage through hole (20a), the cross-section of said tapered pin (3a) being slightly larger than the opening of through hole (20a);
said plug (3) has an upper internal axial dead hole (30) with a bottom threaded section (30a).

2. Mechanical connection device as defined in claim 1 characterised in that the fixture has a section with polygonal profile (1c) with larger cross-section upstream the cylindrical hole (1a) designed to be exactly coupled with a corresponding polygonal profile (2c) situated on the abutment (2) upstream the point (P).

3. Mechanical connection device as defined in claim 1, characterised in that the internal axial hole (20) of the abutment (2) is provided with a section (20b) with larger cross-section upstream the point (P) designed to exactly engage the corresponding section (3b) of the plug (3); it being provided that the same hole (20) of the abutment (2) is provided with a section (20c) with larger cross-section upstream the section (20b) designed to exactly engage the cylindrical section (3c) towards the top of the plug (3).

4. Mechanical connection device as defined in claim 3, characterised in that the plug (3) is provided with threading (40) on the section (3b) that engages with the threading (40a) on the section (20b) of the hole (20) obtained on the abutment (2).
